(19) United States
(12) Patent Application Publication
(10) Pub. No.: US 2011/0000674 A1
(43) Pub. Date: Jan. 6, 2011

(54) REMOTELY CONTROLLABLE MANIFOLD

(75) Inventors: LUIS E. MENDEZ, HOUSTON, TX (US); PAUL JOSEPH, MISSOURI CITY, TX (US); TODD C. JACKSON, HOUSTON, TX (US)

Correspondence Address: CANTOR COLBURN LLP, 20 Church Street, 22nd Floor, Hartford, CT, 06103, US

(73) Assignee: BAKER HUGHES INCORPORATED, HOUSTON, TX (US)

(21) Appl. No.: 12/497,158

(22) Filed: Jul. 2, 2009

(51) Int. Cl. E21B 34/00; F16K 11/00

(52) U.S. Cl. 166/316; 166/319; 166/332.2; 166/66.6; 166/66.5; 137/884

(57) ABSTRACT

A downhole manifold configured to manage fluid flow to or from a subterranean formation including a housing in operable communication with two or more fluid pathways and having one or more ports for fluid communication with a flow channel; and a valve stem disposed within the housing and actuable to fluidly select one of the two or more fluid pathways and to fluidly communicate that pathway with the one or more ports.

### CROSS REFERENCE TO RELATED APPLICATIONS

This application contains subject matter related to the subject matter of co-pending applications, which are assigned to the same assignee as this application, Baker Hughes Incorporated of Houston, Tex. The below listed applications are hereby incorporated by reference in their entirety:

U.S. patent application Ser. No. 12/497,123, Attorney Docket No. 274-48843-US (BAO0303US), entitled REMOTELY CONTROLLABLE VARIABLE FLOW CONTROL CONFIGURATION AND METHOD filed Jul. 2, 2009.

### BACKGROUND

In fluid flowing systems, balance of a profile of fluid flow may be necessary in order to optimize the system. One example of such is in the downhole drilling and completion industry where fluids flowing into or out of a borehole, from or to a subterranean formation are subject to fingering due to varying permeability of the formation and frictional pressure drops. Controlling flow profiles that have traditionally been attempted using such devices are known in the art as inflow control devices. These devices work well for their intended use but are fixed tools that must be positioned in the completion as built and to be changed requires removal of the completion. As is familiar to one of ordinary skill in the art, this type of operation is expensive. Failure to correct profiles, however, is also costly in that for production wells that finger, undesirable fluid production is experienced and for injection wells, injection fluids can be lost to the formation. For other types of borehole systems, efficiency in operation is also lacking. For the foregoing reasons, the art would well receive a flow control configuration that alleviates the inefficiencies of current systems.

### SUMMARY

A downhole manifold configured to manage fluid flow to or from a subterranean formation including a housing in operable communication with two or more fluid pathways and having one or more ports for fluid communication with a flow channel; and a valve stem disposed within the housing and actuable to fluidly select one of the two or more fluid pathways and to fluidly communicate that pathway with the one or more ports.

A manifold including a housing; a pressure drop pathway within the housing, the pressure drop pathway being in operable communication with a number of orifices; and a selectively positionable valve stem having a transverse flow channel therethrough, the flow channel being selectively alignable with a set of orifices to permit fluid exit from the pressure drop pathway.

### BRIEF DESCRIPTION OF THE DRAWINGS

Referring now to the drawings wherein like elements are numbered alike in the several Figures:

FIG. 1 is a schematic axial section view of a remotely controllable variable inflow control configuration as disclosed herein;

FIG. 2 is an axial view of the embodiment illustrated in FIG. 1 taken along section line 2-2 in FIG. 1;

FIG. 3 is an axial view of the embodiment illustrated in FIG. 1 taken along section line 3-3 in FIG. 1;

FIG. 4 is a schematic illustration of the selector disclosed herein with an alternate motor drive configuration;

FIG. 5 is a schematic axial section view of an alternate embodiment of a remotely controllable variable inflow control configuration as disclosed herein;

FIG. 6 is an axial view of the embodiment illustrated in FIG. 5 taken along section line 6-6 in FIG. 5;

FIG. 7 is an axial view of the embodiment illustrated in FIG. 5 taken along section line 7-7 in FIG. 5;

FIG. 8 is a schematic perspective view of an alternate embodiment of a remotely controllable manifold as disclosed herein;

FIG. 9 is a schematic perspective section view of the embodiment of FIG. 8;

FIG. 10 is a side section view of the embodiment of FIG. 8;

FIG. 11 is a schematic perspective view of an alternate embodiment of the remotely controllable manifold;

FIG. 12 is a schematic perspective view of an alternate remotely controllable manifold; and

FIG. 13 is a plan view of the embodiment of FIG. 12

### DETAILED DESCRIPTION

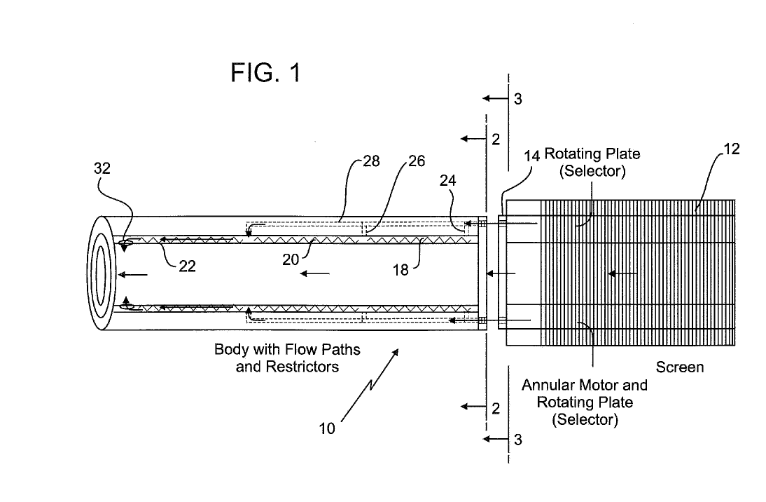

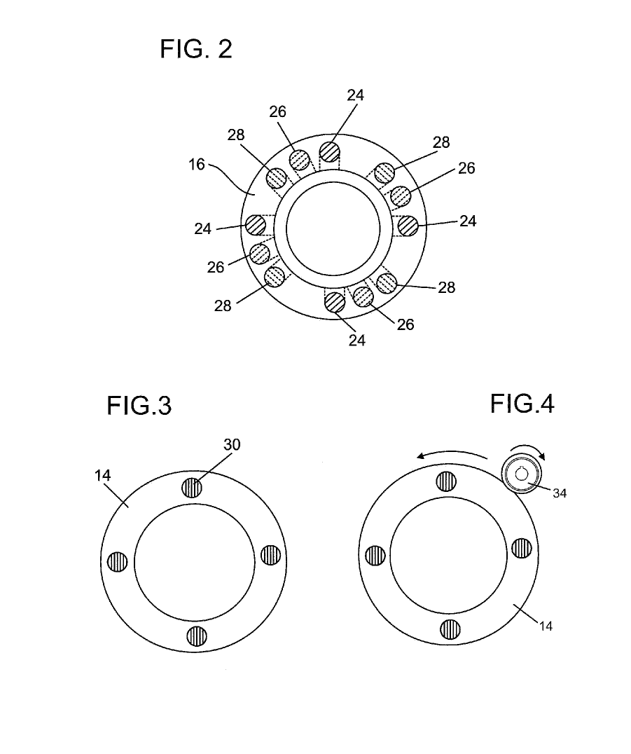

Referring to FIG. 1, a configuration 10 is schematically illustrated to include a screen section 12, a selector 14 and a body 16 having one or more flow restrictors 18, 20, 22 (for example; no limitation intended) disposed in seriatim. The body further includes a number of flow channels 24, 26, 28 (again for example; no limitation intended)) that in one embodiment occur in sets about the body 16 as illustrated. It is to be understood that the number of restrictors need only be a plurality (this embodiment type) for variability in function as taught herein and need only be one if the adjustability is simply on or off. There is no upper limit to the number of restrictors that may be employed other than practicality with respect to available space and length of the tool desired or reasonably possible given formation length, etc. The number of flow channels in each set of flow channels represented will match the number of restrictors for reasons that will become clearer hereunder. The number of sets of flow channels however will be dictated by the available space in the body 16 and the relative importance to avoid a pressure drop associated with the number of channels as opposed to that facilitated by the restrictors 18, 20, 22 themselves. Generally, it will be undesirable to have additional flow restriction, causing a pressure drop, at the interface of the channels or at the selector 14. This is mediated by the cross sectional dimension of the channels and the cross sectional dimension of selector ports 30 as well as the actual number of sets of channels and the actual number of selector ports 30 aligned with channels. Stated alternately, the selector ports 30 can affect flow in two ways that are relevant to the invention. These are in the size of the opening representing each port 30 and the number of ports 30. Because it is desirable to avoid flow restriction in this portion of the configuration, the greater the size and number of ports 30 the better. This is limited by available annular space as can be seen in FIG. 3 but more so by the number of channels in each set of channels (that take up significantly more space in the annular area of the body 16) as can be seen in FIG. 2. Because the number of channels can reduce the number of sets of channels that can be employed and the embodiment discussed uses only one port per set of channels. Accordingly the number of ports possible in this embodiment is limited more by the number of channels than it is by the annular area of the selector itself

The reason there is a plurality of channels in each set of channels for a particular configuration and a plurality of restrictors for that same particular configuration is to present a number of selectable pathways (associated with each channel) for fluid flow that will be directed (in the illustrated embodiment): 1) through all of the plurality of restrictors; 2) through some of the plurality of restrictors; or 3) through one of the plurality of restrictors. Further, it is noted that each restrictor of the plurality of restrictors may have its own pressure drop thereacross or the same pressure drop thereacross. They may all be the same, some of them may be the same and others different, or all may be different. Any combination of pressure drops among each of the plurality of flow restrictors in a given configuration is contemplated.

Referring directly to FIG. 1, there is a pathway created that includes restrictors 18, 20 and 22. That pathway is associated with channel 24. Where fluid is directed to channel 24, the pressure drop for that fluid will be the sum of pressure drops for the plurality of restrictors presented, in this case three (each of 18, 20 and 22). Where fluid is directed alternatively to channel 26, the fluid bypasses restrictor 18 and will be restricted only by whatever number of restrictors are still in the path of that fluid, in this case restrictors 20 and 22. In this case the pressure drop for fluid flowing in channel 26 will be the sum of pressure drops from restrictors 20 and 22. Where fluid is directed to channel 28, both restrictors 18 and 20 are bypassed and the only restrictor in the pathway is restrictor 22. In this position, the pressure drop is only that associated with restrictor 22. In each statement made, other pressure dropping properties such as friction in the system are being ignored for the sake of simplicity of discussion. Therefore for a downhole system in which this configuration is used, the pressure drop can be adjusted by selecting channel 24, 26 or 28 as noted. These can be selected at any time from a remote location and hence the configuration provides variability in flow control downhole and in situ.

In addition to the foregoing, in this particular embodiment or in others with even more restrictors arranged in seriatim, another level of restriction is possible. It should be appreciable by a reader having understood the foregoing description that in the illustrated embodiment, since there is annular room in the body 16 as illustrated for another channel, that is not shown but could be created between channels 28 and 24, another level of restriction or pressure drop can be obtained within the same illustrated embodiment. This is by bypassing all of the restrictors 18, 20, 22. This would present effectively no pressure drop due to flow restrictors in the flow pathway since all of them will have been bypassed. In each case the final entry of the fluid into the inside dimension of the configuration is through orifices 32. As should be evident from the foregoing, the configuration provides a number of remotely selectable pressure drops depending upon which channel is selected or the remote ability to shut off flow by misaligning the selector ports with the flow channels, in one embodiment.

The selection capability is provided by selector 14. As was noted earlier, in one embodiment the selector will have a number of ports 30 that matches the number of sets of channels such that it is possible to align each one of the ports 30 with the same type of channel in each set of channels. For example, in the illustrated embodiment of FIG. 3, the selector includes four ports 30 and the body 16 in FIG. 2 includes four sets of channels 24, 26, 28. When the selector is aligned such that one of the ports 30 aligns with, for example, channel 24, each of the other ports 30 will align with the channel 24 of another set of the channels 24, 26, 28. In so doing, the configuration 10 is set to produce a particular pressure drop using the selected number of restrictors 18, 20, 22 associated with a particular channel for each set of channels. Selection is facilitated remotely by configuring the selector 14 with a motor that is electrically or similarly actuated and hence can be commanded from a remote location, including a surface location. The motor may be of annular configuration, such motors being well known in the art, or may be a motor 34 offset from the selector such as that illustrated in FIG. 4. It will be appreciated that the interconnection of the motor 34 with the selector 14 may be of any suitable structure including but not limited to spur and ring gears, friction drive, belt drive, etc.

The configuration 10 possesses the capability of being reactive, not on its own, but with command from a remote source, to change the pressure drop as needed to optimize flow profiles either into or out of the borehole. It is important to note that while the terms “inflow control” have sometimes been used in connection with the configuration disclosed herein, “outflow” is equally controllable to modify an injection profile with this configuration.

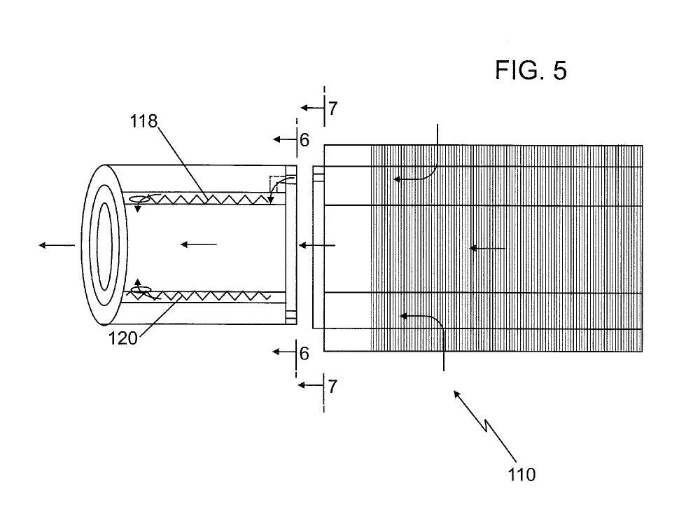

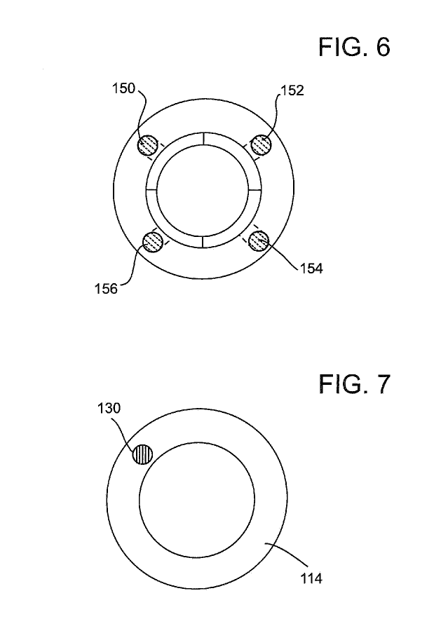

In an alternate embodiment, configuration 110, referring to FIGS. 5, 6 and 7, a maze-type restrictor arrangement whose restrictor operability is known to the art from a similar commercial product known as EQUALIZER MAZE™ is employed. This type of flow restrictor provides restricted axial flow openings followed by perimetrical flows paths followed by restricted axial openings, which sequence may be repeated a number of times. In accordance with the teaching hereof, these types of restrictors are configured in quadrants or thirds or halves of the body 116 and could be configured as fifths, etc. limited only by practicality and available space. In current commercial embodiments of maze-type restrictors, each maze is of the same pressure drop and all function together. In the embodiment disclosed herein however, the restrictors, for example four, are each distinct from the other. This would provide four different pressure drops in a quadrant based maze-type system, three different pressure drops for a triad based maze-type system, two different pressure drops for a half based maze-type system, etc. It is to be understood however that all of the restrictors need not be different from all the others in a particular iteration. Rather each combination of possibilities is contemplated. Referring to FIG. 6, there are illustrated four channels 150, 152, 154, 156, each of which is associated with one restrictor. As illustrated in FIG. 5, restrictors 118 and 120 can be seen, the other two being above the paper containing the view and behind the plane of the paper containing the view, respectively. The selector 114 of the illustrated embodiment, FIG. 6, includes just one port 130 that can be manipulated via a motor similar to the motor possibilities discussed above to align the one port 130 with one of the channels 150, 152, 154, 156. By so doing, a selected pressure drop is available by command from a remote location including from a surface location (note such remote actuation is contemplated for each iteration of the invention). The embodiment is useful in that it allows for a more compact structure overall since each different pressure drop restrictor exists in the same longitudinal section of body rather than requiring a seriatim configuration that causes the body to be longer to accommodate the daisy-chained restrictors.

It is further noted that the embodiment of FIGS. 5-7 can be modified to provide additional possible flow restriction than just each of the restrictors individually. By providing more ports 130 in the selector 114, one or more of the channels 150, 152, 154, 156 can be selected and the average pressure drop of the number of restrictors implicated will prevail for the configuration. It will be appreciated that with consideration of available space, different combinations of restrictors in this embodiment can be selected through rotation of the selector 114.

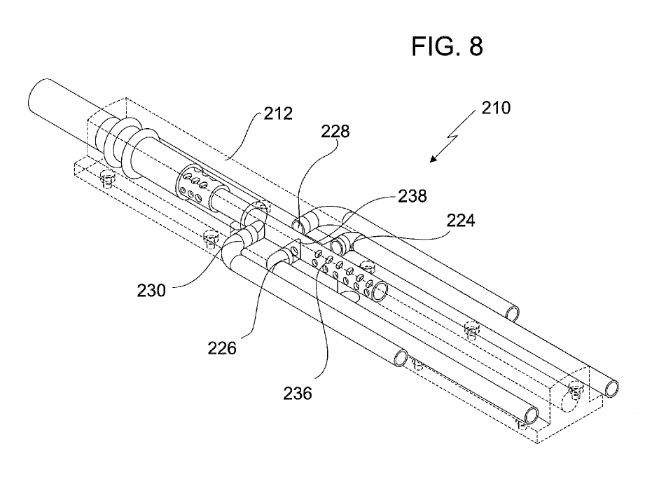

In yet another embodiment, a manifold 210, which may be remotely controllable, and which may be a linear acting manifold is disclosed. Referring to FIGS. 8, 9 and 10, it will be appreciated that a housing 212 includes a longitudinal bore 214 therethrough. In the illustrated embodiment the bore 214 includes two sections 216 and 218 (see FIG. 10) having different dimensions. A valve stem 220 is configured to operably engage the housing 212 to allow, based upon position of the valve stem 220 fluid communication from a variety of different pathways to a port 222, or vice versa. In the embodiment illustrated in FIG. 8 there are four pathways numbered 224, 226, 228, 230, each of which will be connected to a flow channel that provides a different pressure drop such as one of the pressure drop configurations set forth above in connection with FIGS. 1-7. The linear acting manifold allows for remote choosing between the pathways 224, 226, 228 or 230. It will be appreciated that although the manifold is disclosed in connection with remote control of pressure drops for a flow control device such as an inflow control device, it can also be utilized for other duty where selection between alternative flow paths is desired.

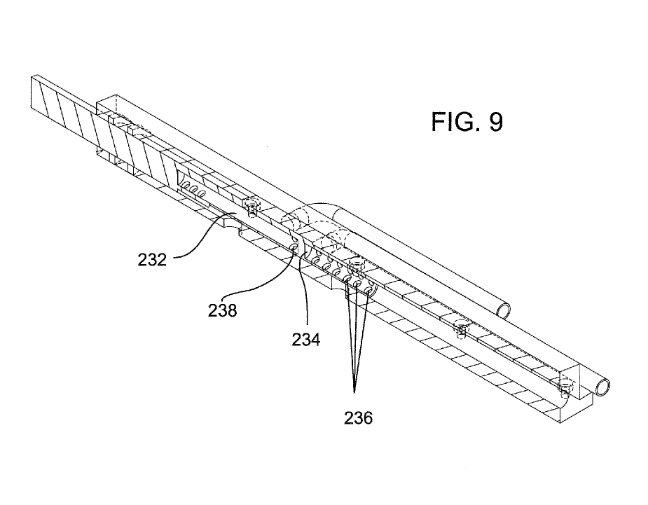

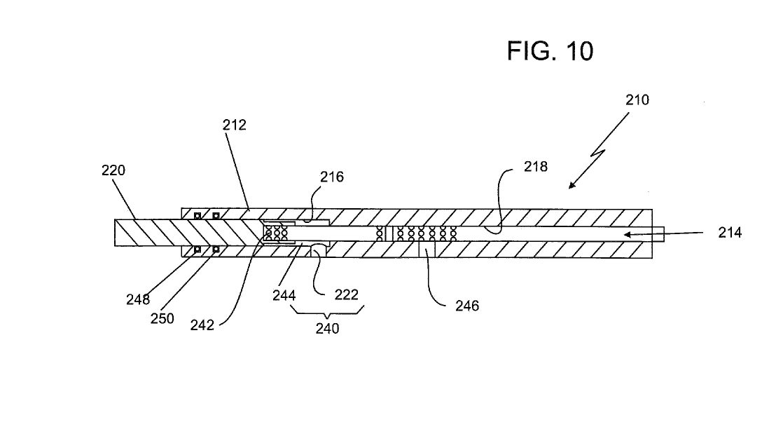

The manifold functions by facilitating communication between a pathway and the port 222 through the valve stem. The valve stem includes a hollow core 232 with a block 234 and a number of apertures therein. The block 234, visible in the cross section view of FIG. 9 is not directly visible in FIG. 8 but it can be located by considering the six axially adjacent apertures 236 and the apertures 238 axially spaced a small distance from apertures 236. The block 234 is between the apertures 236 and 238 and so in FIG. 8, the position of the block 234 is evident.

With direct reference to FIG. 8 then it will be appreciated that for various axial positions of valve stem 220, apertures 238 may be aligned with one of the pathways 224, 226, 228, 230. Since valve stem 220 is a tight fit within housing 212 within bore 218 and due to block 234, only one of the pathways 224, 226, 228, 230 will be in fluid communication with the apertures 238. For example, when it is desired to put pathway 224 into fluid communication with the port 222 the valve stem 220 will be moved axially fully into the housing 212. This will align apertures 238 with pathway 224 and each of the other pathways 226, 228, 230 will be aligned with a blank segment 240 (see bracket, FIG. 10) of the valve stem. By axially moving the valve stem 220 to the left of the Figure, it will be appreciated that apertures 238 will align with pathway 226 as is shown in FIG. 8. Because the block 234 within the valve stem hollow 232 is in this position between pathway 224 and 226, only pathway 226 is selected for fluid communication with port 222. By axially moving the valve stem 220 further to the left of FIG. 8, pathway 228 may be selected with pathway 230 still deadheaded against blank section 240 and block 234 positioned between pathway 226 and 228. Finally pathway 230 may be selected by axially moving the valve stem 220 further to the left of FIG. 8 thereby aligning apertures 238 with pathway 230 while positioning block 234 between pathway 228 and 230.

In each case, once a pathway is selected, the pathway is in fluid communication with the port 222 because apertures 238 allow fluid communication between the pathway and the hollow 232 of valve stem 220 and the valve stem 220 includes apertures 242 that fluidly communicate with annular area 244 defined between valve stem 220 and bore 216 of housing 212. The annular area 244 is directly in fluid communication with port 222.

Apertures 236, introduced above, allow for contingency flow if something runs amok with the manifold 210 by allowing fluid communication between bore 218 and a contingency port 246 that provides fluid communication to the same production path as does the port 222 upon the shifting of a sliding sleeve, not shown but disclosed in copending application entitled “Tubular Valve System and Method”, Attorney Client Docket Number 274-49267-US (BAO0339US) filed Jul. 2, 2009, U.S. patent application Ser. No. 12/497076. The fluid availability to bore 218 may be from one or more of the pathways 224, 226, 228, 230 using a simple T connection or through apertures 236 or from another pathway that may or may not have a pressure drop device associated therewith.

It will be appreciated that two seals 248 and 250 are shown disposed about the valve stem 220 to ensure that fluid does not escape around the valve stem 220. It will be further appreciated that although not necessary and not shown, additional seals may be installed for example between the individual pathways to enhance the individuality of flow when a particular pathway is selected.

The valve stem 220 may be actuated by any number of means including electrically, magnetically, optically, hydraulically, etc.

Each of the pathways 224, 226, 228 and 230 is connected with a configuration having a specific pressure drop so that by selecting a pathway, a specific pressure drop is selected. The pressure drop may be occasioned by any of the foregoing embodiments or the manifold may be substituted for the selector of the foregoing embodiments.

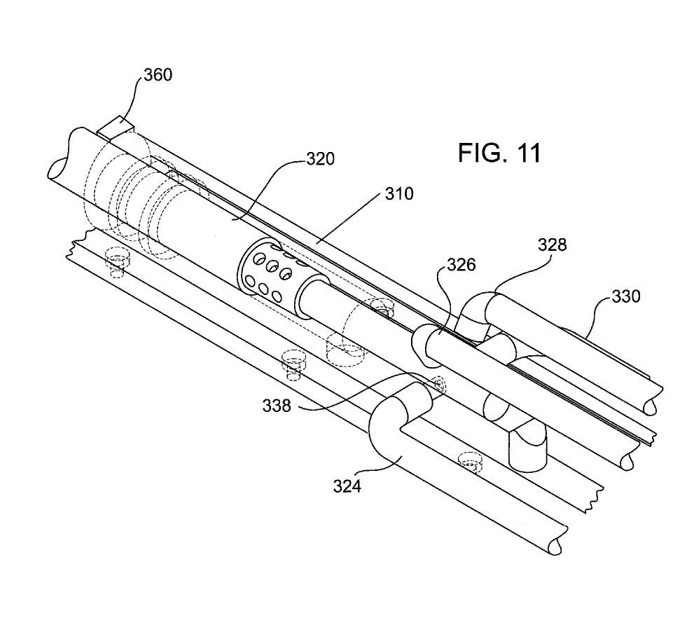

In yet another embodiment, referring to FIG. 11, a rotary actuated remotely controllable flow control device is illustrated. One will recognize that the housing 310 is very similar to the housing 210 and in fact may be identical thereto but with the proviso that because this embodiment is rotationally actuable, the length of the housing can be shorter in this embodiment than it would be in an otherwise equivalently functioning housing 210. The valve stem 320 is also similar but rather than having a number of apertures 238 that are perimetrically positioned of the valve stem 220, the valve stem 320 includes one or more apertures 338 that are arranged to fluidly communicate one of the pathways 324, 326, 328, 330 with the inside hollow of valve 320 while the other pathways remain fluidly noncommunicated. In order to access a selected pathway 324, 326, 328, 330 the valve stem 320 need merely be rotated via a rotational actuator 360 such as a motor, etc. In other ways this embodiment is similar to that described above.

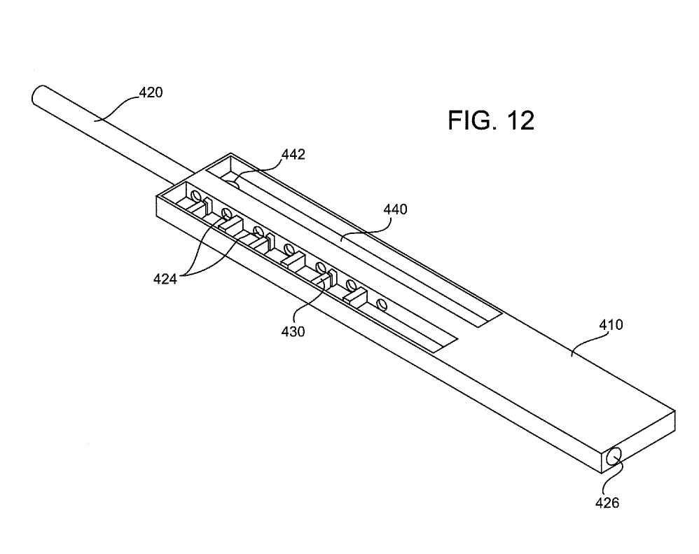

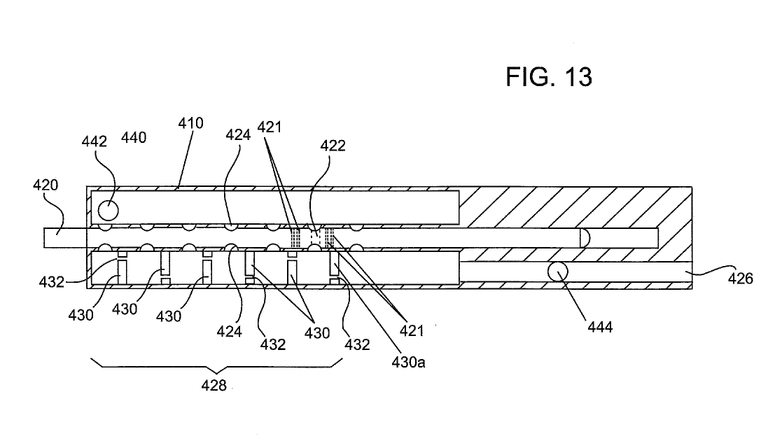

Referring to FIGS. 12 and 13, another embodiment of a manifold that includes its own configuration for selective pressure drop is illustrated. A housing 410 supports a valve stem 420 with seals 421 that presents a substantially transverse flow channel 422, the channel being movable to align with one of a number of housing supported orifices 424 that are themselves aligned with each other. The operability of the system of the transverse flow channel 422 and the orifices 424 being such that when the channel 422 is aligned with a set of orifices 424, a fluid passage from one side of the housing 410 to the other side of the housing is established.

A fluid inlet 426 facilitates fluid delivery to a pressure drop fluid pathway such as tortuous pathway 428 of the housing 410. The pathway comprises, in one embodiment a series of walls 430 each defining a restricted passage 432 through which fluid may flow past the wall 430. The passages 342 in one embodiment are offset each from the passage 342 in the next nearest wall 430 thereby creating the tortuous path utilized to create a pressure drop in the fluid flowing therealong. Other configurations for creating a pressure drop in this pathway 428 are contemplated. As is evident from the drawing FIGS. 12 and 13, the orifices 424 are arranged along the tortuous pathway such that a different pressure drop due to the distance that the fluid travels through the pathway 428 can be accessed. Access to the different pressure drops is by selective positioning of the valve stem 420, which will move the channel 422 into alignment with orifices 424 adjacent a particular one of the walls 430. In the illustrated position of FIG. 13, fluid from inlet 426 flows into pathway 428 and is slowed by only one of the walls 430a before being permitted to escape the tortuous path 428 through channel 422. The fluid passes through channel 422 into collection area 440 and is directed to an intended location through outlet 442. Outlet 442 in one embodiment leads to a tubing ID whether actually a production pathway or not similar to port 222 in the embodiment of FIG. 11. As will be appreciated from the foregoing, depending upon which wall 430 the channel 422 is adjacent, a longer or shorter tortuous pathway (or even none in the case of the first set of orifices 424) is presented to fluid flowing therethrough before the fluid is permitted to escape the pathway 428 through the channel 422. The resultant pressure drop of the fluid is hence selectable through positioning of the stem 420 as noted above.

A contingency port 444 with functionality similar to the foregoing embodiments is illustrated in FIG. 13.

While preferred embodiments have been shown and described, modifications and substitutions may be made thereto without departing from the spirit and scope of the invention. Accordingly, it is to be understood that the present invention has been described by way of illustrations and not limitation.

1. A downhole manifold configured to manage fluid flow to or from a subterranean formation comprising:
a housing in operable communication with two or more fluid pathways and having one or more ports for fluid communication with a flow channel; and
a valve stem disposed within the housing and actuable to fluidly select one of the two or more fluid pathways and to fluidly communicate that pathway with the one or more ports.

2. A downhole manifold as claimed in claim 1 wherein the two or more pathways are connected to devices having differing pressure drops.

3. A downhole manifold as claimed in claim 1 wherein the valve stem is axially positionable to select one of the two or more fluid pathways.

4. A downhole manifold as claimed in claim 1 wherein the valve stem is rotationally positionable to select one of the two or more fluids pathways.

5. A downhole manifold as claimed in claim 1 wherein the valve stem includes a hollow core.

6. A downhole manifold as claimed in claim 5 wherein the hollow core includes a block.

7. A downhole manifold as claimed in claim 1 wherein the valve stem includes one or more apertures positionable to fluidly communicate a hollow core of the valve stem with a selected one of the two or more pathways.

8. A downhole manifold as claimed in claim 1 wherein the valve stem includes one or more apertures to communicate a hollow core of the valve stem to the one or more ports.

9. A downhole manifold as claimed in claim 8 wherein the fluid communication pathway between the hollow core of the valve stem and the one or more ports includes an annular area defined by the valve stem and the housing.

10. A downhole manifold as claimed in claim 1 wherein the housing includes a bore having a first diameter and a bore having a second diameter the first and second bores being receptive to the valve stem.

11. A downhole manifold as claimed in claim 10 wherein the portions of the valve stem are in fluid communication inhibited proximity with the housing.

12. A downhole manifold as claimed in claim 11 wherein the valve stem includes at least one seal.

13. A downhole manifold as claimed in claim 1 wherein the valve stem is displaceable electrically.

14. A downhole manifold as claimed in claim 1 wherein the valve stem is displaceable hydraulically.

15. A downhole manifold as claimed in claim 1 wherein the valve stem is displaceable magnetically.

16. A downhole manifold as claimed in claim 1 wherein the valve stem is displaceable optically.

17. A downhole manifold as claimed in claim 1 wherein the housing further includes one or more contingency ports.

18. A downhole manifold as claimed in claim 1 wherein the manifold is remotely controllable.

19. A manifold comprising:
a housing;
a pressure drop pathway within the housing, the pressure drop pathway being in operable communication with a number of orifices; and
a selectively positionable valve stem having a transverse flow channel therethrough, the flow channel being selectively alignable with a set of orifices to permit fluid exit from the pressure drop pathway.

20. A Manifold as claimed in claim 19 wherein the pressure drop pathway is a tortuous pathway.

21. A Manifold as claimed in claim 19 wherein the valve stem further includes one or more seals thereon adjacent the transverse flow channel.

22. A Manifold as claimed in claim 19 wherein the pressure drop pathway comprises a number of walls closing the pathway, each wall defining a passage therethrough.

23. A Manifold as claimed in claim 22 wherein each set of orifices is aligned and disposed adjacent one of the number of walls closing the pathway.
